(19) United States
(12) Patent Application Publication
(10) Pub. No.: US 2019/0367345 A1
(43) Pub. Date: Dec. 5, 2019

(54) Special bottle cap opening, gripping device called an Easy Grip

(71) Applicants: Frank Xavier Billmeier, Carmel, IN (US); Alex Francis Billmeier, Fishers, IN (US)

(72) Inventors: Frank Xavier Billmeier, Carmel, IN (US); Alex Francis Billmeier, Fishers, IN (US)

(21) Appl. No.: 16/195,921

(22) Filed: Nov. 20, 2018

Related U.S. Application Data
(60) Provisional application No. 62/680,838, filed on Jun. 5, 2018.

(51) Int. Cl. B67B 7/16; B67B 7/18

(52) U.S. Cl. CPC B67B 7/16; B67B 7/18

(57) ABSTRACT

A bottle cap opener and gripper made of resilient materials and used for bottle cap removal. It is essentially a circular configuration with a predetermined thickness and has a rough surface on its circumference for improved grip. The top surface is flat and ready for identification or advertisement. The bottom has a series of step cut gripping rings to engage and hold the bottle cap in a fixed position as the device is turned and the cap is twisted and removed from the bottle. The relationship of the center grip and outer circumference provides a leverage by a radius between the turning force at the circumference by the operator and the twist force transferred to the bottle cap. The radius serves to multiply the twist force with the radius of the device and thereby turn the cap easier than by just the operator gripping the cap alone.

### CROSS-REFERENCE TO RELATED APPLICATIONS

This application claims the benefit of United States Provisional Patent Application with Ser. No. 62/680,838 filed Jun. 5, 2018, by Frank Xavier Billmeier and Alex Francis Billmeier. The application is entitled “Special bottle cap opening/gripping device called an Easy Grip”.

### FIELD OF INVENTION

This invention relates to a Special bottle cap opening/gripping device called an Easy Grip. The disclosure relates to lid and closure removal and attachment devices and more particularly pertains to a new lid removal and attachment device for removal and attachment of screw-lids. It relates generally to the removal of lids, caps, or closures from containers, and more particularly to a bottle cap remover that is capable of removing the caps or closures from multiple kinds of bottles with a reduced twisting force. The invention is a bottle opener and, more particularly, to an opener for removing twist-off screw caps/closures from a bottle, can and the like. Twist-off caps are well known in the art. To remove a twist-off cap from a bottle the user, generally, grasps the cap between the thumb and a finger twisting it until it loosens. Finally, this invention relates generally to tools and devices utilized in manipulating bottle caps, including plastic water bottle caps, to and from bottles, twist-off metal crimped-on bottle caps, medicine container caps or similar container caps/closures, whether metal or plastic.

### FEDERALLY SPONSORED RESEARCH

None.

### SEQUENCE LISTING OR PROGRAM

None.

### BACKGROUND

### Field of Invention and Prior Art

As far as known, there are no Special bottle cap opening/gripping devices or the like. It is believed that this product is unique in its design and technologies.

### Background

This background as to the history of bottle caps and openers should be useful. The sale and transport of many liquids or granular materials utilize containers which are generally described as “bottles”. Many such bottles are used in transport and sale of potable liquids such as water, soda, milk and other foods and beverages as well as medicines. Such bottles are also used in the sale and transport of liquids and granular materials which are not suitable for consumption but provide liquids such as cleaning agents or chemicals. While bottles have been provided in a virtually endless variety of shapes, sizes and constructions, perhaps the most common type of bottle in the modern marketplace utilizes a container body defining a reservoir therein and supporting a closed bottom with an upwardly extending filler neck. Such bottles are often made of glass or plastic materials. However, bottles have also been provided which are fabricated from a metal material such as common aluminum or the like. Closure of the typical bottle is provided by a bottle cap/closure which is usually snapped upon the bottle neck or received upon the neck in a twist or threaded engagement.

Of particular interest to the use of the present invention tool are those bottle caps generally described as “twist-off” caps or closures so named because they are removed from and replaced upon the bottle neck in a twisting (rotating) motion upon the bottle neck. While some metal twist-off type bottle caps are crimped upon the bottle neck, most are threaded and secured to cooperating threads on the bottle neck. One of the difficulties encountered using bottles having twist-off type bottle caps arises due to the tight seal which the bottled product requires to avoid leakage and contamination of the bottle contents. For the most part, seal integrity is achieved by a relatively tight attachment of the cap upon the bottle neck. While the use of a tight closure of the cap upon the bottle neck often renders the bottle cap difficult to manipulate and remove, additional difficulties are often created through the use of tear-off integrity closure mechanisms integrally formed on the bottle cap. These integrity closures or seals are often configured to fracture and tear apart when the bottle cap is twisted upon the neck during the initial opening of the bottle. Such integrity closures are very effective in reassuring consumers that the bottle cap has not been previously removed and that the bottle contents are undisturbed and uncontaminated. However, the integrity type closure seals further increase the amount of torque required to initially open a bottle. Thus, despite the advantages of economy, convenience and pervasiveness of bottles utilizing twist type caps, several problems arise for the consumer during typical use. As mentioned above, the need to provide secure closure and a trustworthy leak-proof seal leads manufacturers to provide bottle caps/closures that are securely twisted closed and often embellished with an integrity seal closure mechanism. As a result, it simply takes a substantial torque to twist the typical bottle cap from the bottle neck during use. Additional problems arise in that many bottle caps are relatively small and difficult to manipulate. This problem is particularly frustrating for users such as young children, aged persons and persons having debilitating illnesses such as arthritis or the like.

Heretofore it has been known to manufacture a number of hand held opening devices with no moving parts, but none have provided adequate opening devices for twist-off bottle tops. Moreover, the known prior art fails to disclose a socket-like hand held member for use in opening twist-off bottle tops with fulcrum concept extending from the socket portion to the holding structure. In recent years, many bottle and can manufacturers have converted from the conventional pry-off cap to the now popular twist-off screw cap, so that the user can theoretically remove the twist-off screw cap without the use of any tools, by merely grasping the cap between one's fingers and thumb, and then twisting it off. However, many of these twist-off screw caps are not easily removed, particularly by the old, the very young, and especially by arthritic sufferers, due to a flaw in the manufacture thereof. Accordingly, many of these twist-off screw caps are too tightly secured and, therefore, cannot be twisted off merely by using one's hand. Therefore, in many cases, a tool such as a pair of pliers is used to remove a defective twist-off screw cap, which in most cases would damage the cap so that it cannot be used to reseal the bottle, can and the like. Furthermore, when using one's hand, the user may be cut by an improperly formed twist-off screw cap. Additionally, when there is excessive pressure within the bottle or can, such as when the bottle or can has been shaken before attempting to open same, the twist-off screw cap is propelled into the air upon removal, and can thus cause severe damage to the user or the surroundings.

Millions of people every day remove the twist-off caps/closures from glass and plastic bottles of varying opening diameters by applying a manual twisting force to the screw-top bottle caps, thereby to remove the bottle caps and allow the liquid contents of the bottle, typically water, beer, juice or soda, to be poured out. For most individuals, the removal of a screw-top bottle cap can be usually achieved with relative ease by simply grasping the cap, typically with the thumb and finger of one hand, and rotating the cap in the counter-clockwise direction to unscrew and thus remove the cap from the bottle. On occasion, the cap may be so tightly secured to the container that even a healthy person of ordinary strength may have difficulty unscrewing the bottle cap without the use of a tool such as a wrench or pliers to provide a sufficient twisting force to remove the cap. However, for the elderly and those who suffer from arthritis, for example, the removal of a screw-on bottle cap may on almost all occasions present an insuperable problem since persons so afflicted are often unable to grasp tightly and twist a bottle cap with a sufficiently large torsional force to remove the bottle cap bottle cap without pain or discomfort. As the population of elderly people in the United States continues to grow, the need for a device that would allow them to perform such a basic task as opening a bottle becomes more pressing. There thus exists a need for a device that would allow an individual who suffers from arthritis or who for any other reason is unable to grasp and twist a screwed-on bottle cap with a sufficient torsional force to readily remove the bottle cap without pain or discomfort and to do so with bottle caps/closures of a wide variety of sizes and materials. Many elderly people, disabled people, and people with arthritis can also sometimes have difficulty in opening medicine bottles or containers. Individuals having limited dexterity in their hands and fingers also experience difficulty when attempting to open these closures.

### Problems Solved

The problems are exacerbated in that bottle and container caps are not only small in size and therefore present a limited grip area, they tend to be fabricated of materials which are somewhat slippery and therefore even more difficult to grasp with sufficient gripping force to allow twisting of the bottle cap. Another difficulty with grasping a cap by hand arises due to the abrasive surface on the typical cap, which, with repeated contact, may cause irritation or injury. There arises therefore an unresolved and unsatisfied need in the art for an easy to use, inexpensive and convenient tool for use in opening tight bottle caps.

### PRIOR ART

As far as known, there are no Special bottle cap opening/gripping devices or the like. It is believed that this product is unique in its design and technologies. A novelty search revealed:
A. The U.S. Patent Application 20170320716 by Ranftl submitted in 2017 for TOOL FOR REMOVAL AND CLOSURE OF BOTTLE AND CONTAINER CAPS. This shows a tool which includes a resilient relatively soft tool body defining a closed top surface and a surrounding side surface extending downwardly therefrom. The tool further includes a bottom surface which defines an upwardly extending generally cylindrical recess therein. The recess includes interior sidewalls which in their preferred form support a plurality of gripping ridges or edges. The recess is sized and shaped to receive a portion of a bottle cap thereby allowing the user to grip the tool and squeeze the tool body to force its recess surfaces against the bottle cap in a gripping engagement and thereafter applying a torque or twist to the tool allowing the bottle cap to be easily removed. In its preferred fabrication, the tool further includes a plurality of radially extending relief slots formed in the recess wall to facilitate better gripping action and to allow the recess wall to stretch and expand thereby accommodating different bottle cap sizes. Finally, the tool may utilize a plurality of differently sized recesses arranged in descending order to engage different bottle cap sizes.
B. U.S. Patent Application 20170210607 by Deer was submitted in 2017 for a Screw-Lid Removal and Attachment Device. This application taught a screw-lid removal and attachment device for removal and attachment of screw-lids includes a housing that is tubular. The housing has an annular wall that is deformable and extends downwardly from a top, defining a bottom that is open. The bottom, which defines a cavity positioned in the housing, is substantially complementary to a lid to be removed or attached to a container. A grip is coupled to an exterior of the annular wall. A catch is coupled to an interior of the annular wall. The cavity is configured for insertion of a lid. The grip is configured to be grasped by the user to collapse the annular wall, such that the catch engages the lid. The grip is configured to allow the user to impart a counter-clockwise force to the housing for removal of the lid or a clockwise force to attach the lid.
C. Another U.S. Patent Application 20090277306 was provided by ELWELL in 2009 for a PILL CONTAINER OPENER. This invention showed a container opener that is used by a user to remove a cap of a bottle or container such as, but not limited to, a medicine bottle or container that includes a childproof cap. The container opener includes a cavity that is designed to at least partially receive the cap of a bottle or container. The cavity can include one or more gripping elements designed to engage the cap when inserted in the cavity. The cavity can be designed to receive a plurality of different sized caps. The container can include a magnifier.
D. U.S. Patent Application 20080098853 submitted by Choate in 2008 for a MULTIPLE CONTAINER OPENER. Here is demonstrated a drinking vessel which includes a tab/bottle cap/twist cap opener for aiding in the opening of a beverage can or bottle. Also for cans, the lip of the tab opener is slid underneath the tab to pry it upwards. The bottle cap opener pries open crown caps and a twist-top opener holds twist-top caps. The tab/bottle cap/twist cap opener can be formed integrally to a drinking vessel, on a bottom plate secured to a drinking vessel, as a stand-alone opener or as part of a novelty item such as a picture frame, coaster, or sports article such as a hockey puck or racing wheel, or a picture frame.
E. A U.S. Pat. No. 8,596,167 was issued to Bart in 2013 for a Bottle cap opener. This is a twist-off cap bottle opener having a varying cap engaging radii.
F. Another U.S. Pat. No. 7,267,031 by Burton, et al. was issued in 2007 for a Bottle cap remover. This taught a bottle cap remover that includes a pair of axially nested socket sections of different diameters depending axially from a larger-diameter grasping section. Each of the socket sections includes frictional gripping members along their inner walls that are adapted to frictionally engage different sizes and types of metal and plastic bottle caps, thereby to enable the user to twist off and remove the bottle caps by applying a relatively small twisting force to the grasping section.
G. U.S. Pat. No. 6,098,497 by Larose was issued in 2000 for a Bottle opening device. This provides a bottle opening device worn on the user's hand or wrist. The bottle opener includes a round member having interior ridges and grooves for mating with a twist-off bottle cap, a slidable hook for removing a pry-off bottle cap, and a magnet for retaining the bottle cap. The bottle opener may include a watch, a sound emitter such as an alarm, and a light, possibly to assist with reading the watch.
H. U.S. Pat. No. 4,979,407 by Hernandez, et al. was issued in 1990 for a For a Bottle opener. Here is shown a bottle opener that includes a handle having a substantially circular first bottle opener portion at one end thereof with a centrally disposed first opening extending through the first bottle opener portion to remove a twist-off screw cap from a bottle and can, and a substantially flat second bottle opener portion extending outwardly from the opposite end of the handle with a second opening extending through the second bottle opener portion to remove a pry-off cap from a bottle and can, the second bottle opener portion including an off-set tab at a free end thereof in order to lift a ring-like portion of a lift-off tab of a flip top can to open same. The first bottle opener portion and the handle are constructed in one piece, from a rubber-like material. Engagement members are provided on the walls of the first opening of the first bottle opener portion for gripping and turning the twist-off screw cap. A slot is provided in the first bottle opener portion extending from the first opening therein through the first bottle opener portion and into the handle in order to permit expansion of the first bottle opener portion when being inserted onto the screw cap. The handle includes finger portions on opposite sides of the slot to maintain the first bottle opener portion in contact with the screw cap when the screw cap is being twisted. Preferably, a metal reinforcing member is disposed within the handle.
I. U.S. Pat. No. 4,967,622 by Phillips was issued in 1990 for a Beverage container opener. This invention shows a multiple-function beverage container opener which features an ergonomically-shaped, elongate body having a stay-on tab opener on one end thereof, a crimped-on bottle cap opener on the opposite end thereof, and twist-off bottle opener in a central socket portion thereof. The stay-on tab opener is characterized by an arcuate loop formed between outboard and inboard arcuate-shaped lances. The arcuate-shaped lances and loop are provided with a radius that is substantially similar to the rim of the beverage container lid so that the loop fits between the tab handle and the rim of the beverage container. A ramp is coined in the arcuate loop to further assist in the camming of the tab handle upwardly into the arcuate loop for further pivoting and opening of the scored closure of the stay-on tab opener. The socket formed in the central portion of the opener contains and arcuate array of gear-shaped socket teeth provided with a pitch that is approximately twice the pitch of the gear-shaped cap teeth disposed on the twist-cap, the socket teeth having a nominal diameter somewhat greater than the diameter of the cap teeth so that a quick and effective fit is achieved for the operation of the twist-off cap. The end of the opener opposite the stay-on tab opener contains a pry-bar type opener for crimped-on bottle caps.
J. U.S. Pat. No. 4,455,894 by Roberts issued in 1984 for a Hand held opening apparatus. This demonstrates a hand held opening apparatus with no moving parts which includes three distinctly different opening devices. One of the opening devices consists of a centrally located socket-like portion at the center of a substantially flat body portion. This opening device is adapted to be telescoped over twist-off bottle cap members. A second opening device is located at one end of the flat body portion and consists of a wedge member insertable beneath a ring pull tab of a can end easy opening member. The third opening device is used to open plastic bags or the like and consists of a blade laminated within upper and lower portions of the flat body portion at the end opposite the second opening device. The body portion may be made from a plastic material and a permanent magnet may be embedded in one surface of the flat body member to permit the apparatus to be held magnetically when not in use.
K. Another U.S. Pat. No. 4,433,597 by Rowland issued in 1984 for a Combined bottle cap opener. Here is taught a bottle cap opener for prying off or twisting off tapered caps including a palm size top, a base holding a tang for engaging the cap. In a modified form the top is formed of transparent plastic. A plastic or paper member for receiving an imprinted logo is attached to the top. The device in one form includes magnets embedded in the base. Still another form is formed with an opening in the base for receiving an attachment member.
L. Another U.S. Pat. No. 1,752,189 by LOTZ issued in 1930 for a JAR COVER REMOVER AND FASTENER. This invention relates to a device for applying and removing covers or caps from Jars and like containers. The principal object of the invention is the provision of a device of improved construction, which may be attached to a suitable support or wall in fixed relation thereto, which is adapted to receive and effectually grip the cover or cap of a jar or like container, while the latter is being turned, for the purpose of either securely applying or screwing the cover or cap thereon, or for removing or unscrewing the same therefrom, and which enables these operations to be accomplished without spilling the jar or container contents.
M. A U.S. Design Pat. D 796,283 by Kiela, II, et al. issued in 2017 for a Bottle opener. It is an ornamental design for a bottle opener, as shown and described in its sketches.
N. Finally a U.S. Design Pat. D 792,179 by Hsieh issued in 2017 for a Hand tool with bottle opener. It shows an ornamental design for a hand tool with bottle opener.

As can be observed, none of the prior art has anticipated or caused one skilled in the art of bottle cap opening/gripping devices to see this new invention by the Billmeiers as obvious to a person skilled in the ordinary art of the industry. The bottle cap opening/gripping device called an Easy Grip provides an answer to the opening a bottle cap that is slippery and therefore even more difficult to grasp with sufficient gripping force to allow easy twisting off and removal of the bottle cap. This grasping of a cap by hand arises causing irritation or injury to ones hands due to the abrasive surface of the cap. The new invention prevents these injuries as well as providing a better grip on the slippery caps.

### SUMMARY OF THE INVENTION

This invention is a special bottle cap opening/gripping device called an Easy Grip. The preferred embodiment is a Special bottle cap opening/gripping device made of a resilient and durable material and is comprised of features: (a) a circumference for a given diameter, the circumference having a circumference surface, a surface grip, and a chamfer on circumference edges; (b) a set thickness; (c) a top surface for logo, advertisement, etc.; (d) a bottom having a series of step cut gripping rings; and (e) a center aperture/through hole from the top surface through to the bottom wherein an operator uses the device and engages the top of a bottle cap with the series of step cut gripping rings and thereby holding the cap/closure while the operator then can twist the diameter of the device by holding a circumference surface which permits the device to grip the bottle cap at gripping rings and to multiply the twist force with the radius of the device and thereby turn the cap more easily than by just the hand of the operator gripping the cap alone.

The newly invented bottle cap opening/gripping device 30 called an Easy Grip may be manufactured at low volumes by very simple means and in high volume production by more complex and controlled systems.

### Objects and Advantages

There are several objects and advantages of the special bottle cap opening/gripping device. There are currently no known cap opening/gripping devices that are effective at providing the objects of this invention.

The special bottle cap opening/gripping device called an Easy Grip has various advantages and benefits:

TABLE A
Benefits and Advantages.

| Item | Advantages |
|---|---|
| 1 | Is a simple design |
| 2 | Is easy to use |
| 3 | Incorporates a single piece design, i.e. no moving parts |
| 4 | Can adapt for various sizes |
| 5 | Can assist weak handed - injured, arthritic, elderly, etc. |
| 6 | Is ergonomically sound |
| 7 | Will not rust |
| 8 | Has no electric cord |
| 9 | Needs no batteries |
| 10 | Offers leverage, as needed |

Finally, other advantages and additional features of the present Special bottle cap opening/gripping device called an Easy Grip will be more apparent from the accompanying drawings and from the full description of the device. For one skilled in the art of bottle opening and gripping devices, it is readily understood that the features shown in the examples with this product are readily adapted to other types of bottle opening and gripping devices and their uses.

### DESCRIPTION OF THE DRAWINGS—FIGURES

The accompanying drawings, which are incorporated in and constitute a part of this specification, illustrate an embodiment of the Special bottle cap opening/gripping device called an Easy Grip that is preferred. The drawings together with the summary description given above and a detailed description given below serve to explain the principles of the opening and gripping device. It is understood, however, that the device is not limited to only the precise arrangements and instrumentalities shown.

FIGS. 1 A through 1 D are sketches of the general easy grip for bottle caps device for various sized applications.

FIGS. 2 A though 2 L are sketches of the easy grip for bottles device with components and features noted as well as section views.

FIGS. 3 A through 3 D are sketches of the prototype sample of the easy bottle cap grip device with the components and features shown from generally a top view and a sketch of the engineering concepts.

FIGS. 4 A through 4 C are additional sketches of the easy grip for bottle caps device.

FIGS. 5 A through 5 E are sketches of using the easy grip for bottle cap device.

FIGS. 6 A through 6 F are sketches of prior art for bottle cap gripping devices.

### DESCRIPTION OF THE DRAWINGS—REFERENCE NUMERALS

The following list refers to the drawings:

TABLE B
Reference numbers

| Ref # | Description |
|---|---|
| 30 | easy grip for bottle cap device 30 a Preferred Special |
| | bottle cap opening/gripping device with step cut gripping |
| | rings 50 centered on device center point 32 |
| 32 | center point 32 X-Y for device 30, prototype 33, drawing 35 |
| 33 | prototype 33 of easy grip for bottle cap device |
| 35 | sketch drawing 35 of device 30 |
| 36 | easy grip for bottle cap/closure device 36, an Alternative |
| | 3 bottle cap opening/gripping device with step cut gripping |
| | rings 50 centered off set from center aperture 45 a distance |
| | OS |
| 37 | easy grip for bottle cap/closure device 37, an |
| | Alternative 4 bottle cap opening/gripping device with step |
| | cut gripping rings 50 centered off set on an offset angle |
| | OA from center aperture 45 |
| 40 | top view 40 of prototype 33 of easy grip 30 |
| 41 | chamfer 41 on circumference |
| 41T | thickness 41T of pre-determined for easy grip devices 30, 36, |
| | 37 (example 0.75, 1.00, 1.25 inches etc.) |
| 42 | circumference 42 |
| 42A | circumference surface 42A |
| 43 | diameter 43 |
| 44 | center point 44 X-Y of the offset inner cuts/milling, turning |
| | for device 30, prototype 33, and drawing |
| 45 | center aperture/through hole 45 at top surface 47 |
| 46A | surface grip 46A (diagonal) on circumference surface 42A |
| 46B | surface grip 46B (diamond knurl) on circumference surface 42A |
| 47 | top surface 47 for logo, advertisement, etc. |
| 48 | bottom surface 48 |
| 49 | center aperture/bottom step cut 49 at bottom surface 48 |
| 50 | step cut gripping rings 50, essentially square or perpendicular |
| | to the horizon cuts |
| 55 | step cut gripping rings 55, essentially rounded corner |
| | (Alternative of cuts perpendicular to the horizon cuts |
| 57 | sloped cut gripping ring 57, essentially a sloped grip area staring |
| | from the top surface 47 at the aperture 45 and widening/ |
| | increasing in diameter to the bottom surface 48 |
| 60 | bottle 60 |
| 65 | bottle cap/closure 65 |
| 70 | un-screwing 70 bottle cap 65 by operator 100 |
| 81 | prior art device 81 is U.S. Pat. No. 1,752,189 |
| 82 | prior art device 82 is U.S. Pat. No. 4,455,894 |
| 83 | prior art device 83 is U.S. Pat. No. D 796,283 |
| 84 | prior art device 84 is U.S. Pat. No. 8,596,167 |
| 85 | prior art device 85 is U.S. Pat. No. 7,267,031 |
| 86 | prior art device 86 is application Ser. No. 2017/0320716 |
| 100 | operator 100 |
| 105 | hand(s) 105 of operator 100 |
| CR | cap resistance force CR |
| TF | original twist force TF |
| GF | gripper twist force GF |
| LR | lid radius LR |
| GR | gripper radius GR |
| MADV | advantage or increase force MADV = GR/LR |
| OS | Off-Set OS = distance from center of device 32 and center |
| | of off-set cuts 42 |
| OA | Off-Set Angle = angle of offset from center of device 32 |
| | at a top surface and center of offset cut 49 at a bottom surface |

### Detailed Description of Preferred Embodiment

This invention relates to a Special bottle cap opening/gripping device called an Easy Grip. The disclosure relates to lid removal and attachment devices and more particularly pertains to a new lid/closure removal and attachment device for removal and attachment of screw-lids. It relates generally to the removal of closures from containers, and more particularly to a bottle cap/closure remover that is capable of removing the caps from multiple kinds of bottles with a reduced twisting force. The invention is a bottle opener and, more particularly, to an opener for removing twist-off screw caps from a bottle, can and the like. Twist-off caps are well known in the art. To remove a twist-off cap from a bottle the user, generally, grasps the cap between the thumb and a finger twisting it until it loosens. Finally, this invention relates generally to tools and devices utilized in manipulating bottle caps/closure, including plastic water bottle caps, to and from bottles, twist-off metal crimped-on bottle caps, medicine container caps or similar container caps, whether metal or plastic.

The advantages for the special bottle cap opening/gripping device 30 called an Easy Grip are listed above in the introduction. Succinctly the benefits are that the device:
A. Is a simple design
B. Is easy to use
C. Incorporates a single piece design, i.e. no moving parts D. Can adapt for various sizes
E. Can assist weak handed—injured, arthritic, elderly, etc.
F. Is ergonomically sound
G. Will not rust
H. Has no electric cord
I. Needs no batteries
J. Offers leverage, as needed

The preferred embodiment of the special bottle cap opening/gripping device 30 called an Easy Grip is made of a resilient and durable material and is comprised of features: (a) a circumference 42 for a given diameter 43, the circumference having a circumference surface 42A, a surface grip 46A, 46B, and a chamfer 41 on circumference edges; (b) a set thickness 41T; (c) a top surface 47 for logo, advertisement, etc.; (d) a bottom 48 having a series of step cut gripping rings 50; and (e) a center aperture/through hole 45 from the top surface 47 through to the bottom 48 wherein an operator 100 uses the device 30 and engages the top of a bottle cap 65 with the series of step cut gripping rings 50 and thereby holding the cap/closure 65 while the operator 100 then can twist the diameter 43 of the device 30 by holding a circumference surface 42A which permits the device to grip the bottle cap at gripping rings 50 and to multiply the twist force with the radius of the device and thereby turn the cap 65 more easily than by just the hand 105 of the operator 100 gripping the cap 65 alone.

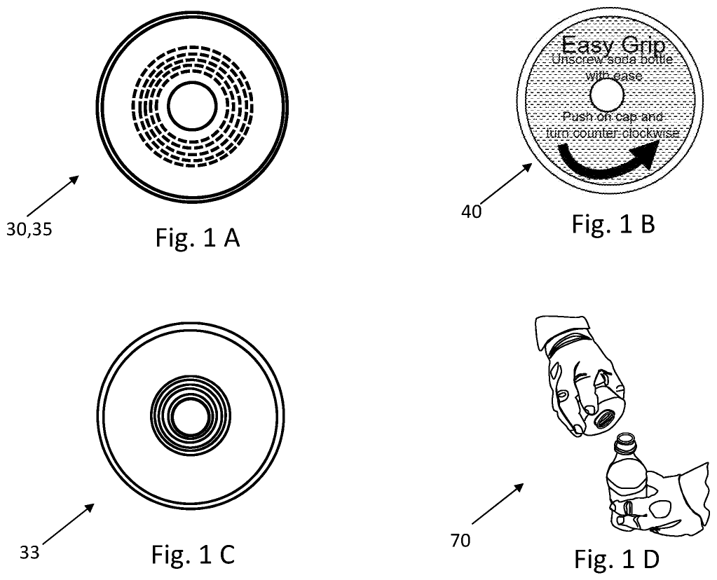

There is shown in FIGS. 1-6 a complete description and operative embodiment of the special bottle cap opening/gripping device 30 called an Easy Grip. In the drawings and illustrations, one notes well that the FIGS. 1-6 demonstrate the general configuration and use of this product. The various example uses are in the operation and use section, below.

The accompanying drawings, which are incorporated in and constitute a part of this specification, illustrate an embodiment of the Special bottle cap opening/gripping device 30 called an Easy Grip that is preferred. The drawings together with the summary description given above and a detailed description given below serve to explain the principles of the bottle cap opening/gripping device 30. It is understood, however, that the device 30 is not limited to only the precise arrangements and instrumentalities shown. Other examples of gripping and opening devices and uses are still understood by one skilled in the art of gripping and opening devices to be within the scope and spirit shown here.

FIGS. 1 A through 1 D are sketches of the general easy grip for bottle caps device 30 for various sized applications. In these sketches are shown:

an easy grip for bottle cap device 30 a Special bottle cap opening/gripping device; a prototype 33 of easy grip for bottle cap device; a sketch of a drawing 35 of device 30; a Top view 40 of prototype 33 of easy grip 30; and an operation of un-screwing 70 bottle cap 65 by operator 100; an operator 100; a hand(s) 105 of operator 100.

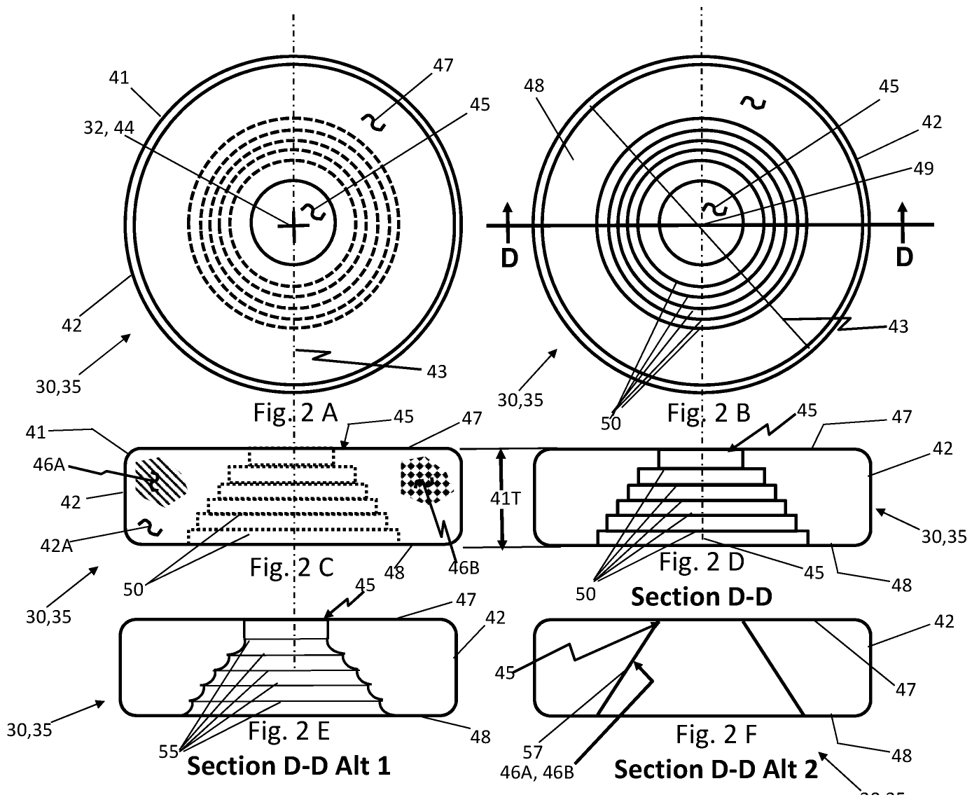

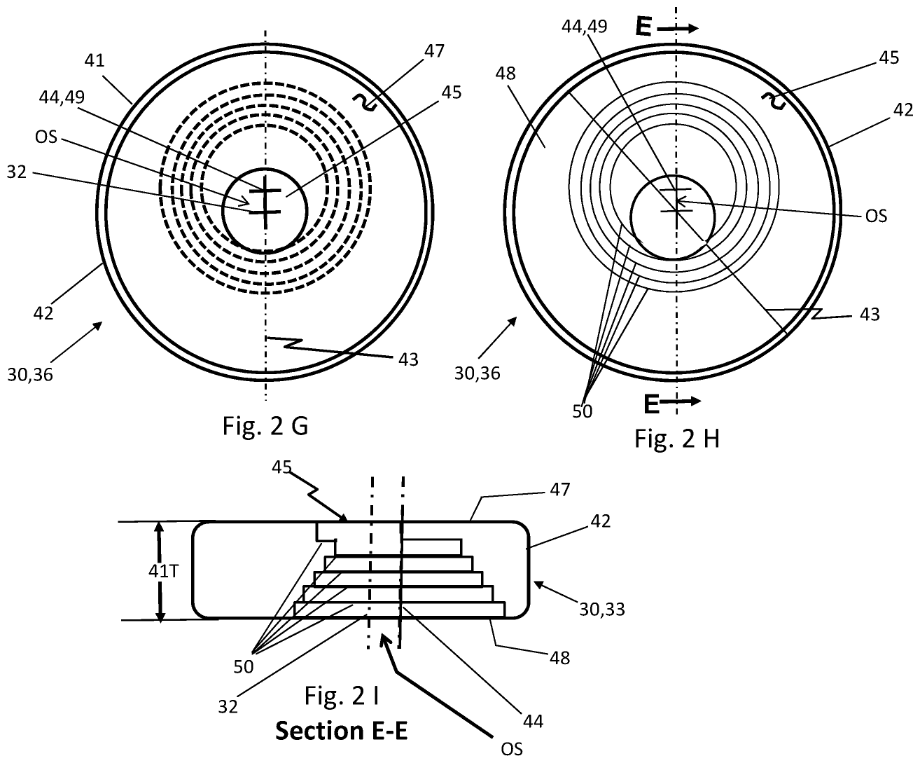

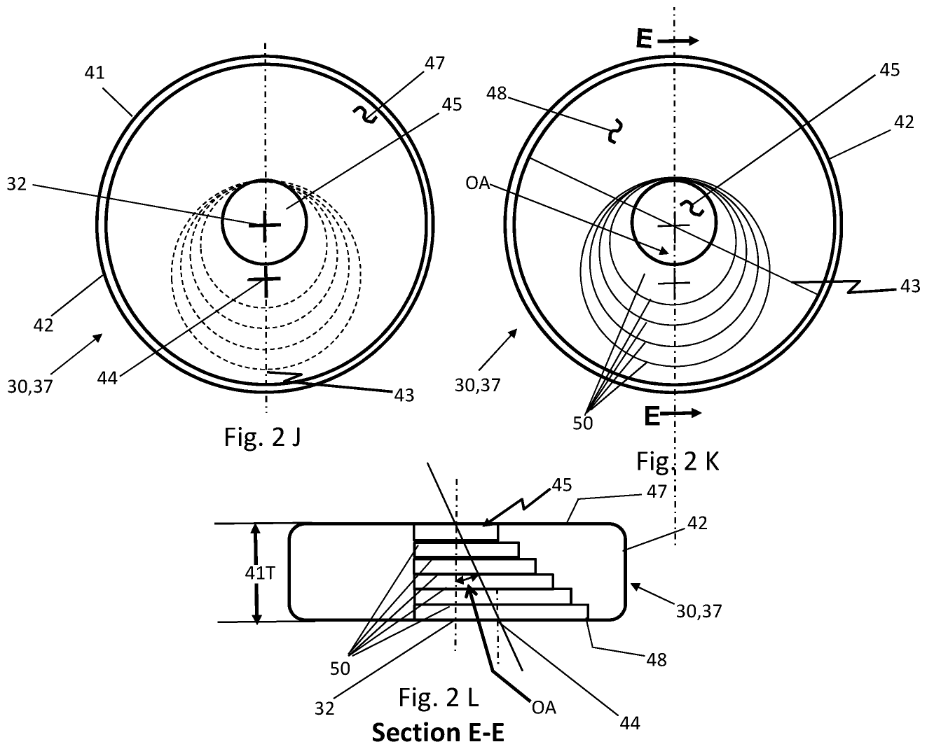

FIGS. 2 A though 2 F are sketches of the easy grip for bottles device 30 with components and features noted. Portrayed in these views are: an easy grip for bottle cap device 30 a preferred Special bottle cap opening/gripping device with cutting rings 50 centered on device center point 32; a sketch drawing 35 of device 30; a chamfer 41 on circumference; a set, predetermined thickness 41T of easy grip device 30 (example 0.75, 1.00, 1.25 inches etc.); a circumference 42; a circumference surface 42A; a diameter 43; a center aperture/through hole 45; a surface grip 46A (diagonal) on circumference surface 42A; a surface grip 46B (diamond knurl) on circumference surface 42A; a top surface 47 for logo, advertisement, etc.; a bottom surface 48; and a series of at least two step cut gripping rings 50. Various sizes and size ranges are anticipated. For example, a 1½ to 1⅝ inch range can be one device; a 1⅛ to 1 1/14 inch can be a second device, etc. The overall diameter above 5 inches may be somewhat impractical for an average hand to grip, so it is anticipated that screw lids beyond a 4 inch diameter may need a different designed device. At 4 inches for a lid, there is still a 1 inch use space or about ½ inch wide on the ring device 30 between the lid, bottle cap/closure 65 and step cut gripping rings 50 to the circumference 42 of the device 30. The Sections D-D, Alternative 1 and Alternative 2 are shown in FIGS. 2 D through 2 F. These show the preferred squared step cut gripping rings 50, rounded step cut gripping rings 55 and a sloped configuration 57. Here are the step cut gripping rings 50, essentially square or perpendicular to the horizon cuts; the Step cut gripping rings 55, essentially rounded corner of cuts perpendicular to the horizon cuts; and the Sloped cut gripping ring 57, essentially a sloped grip area viewing from the top surface 47 at the aperture 45 and widening/increasing in diameter to the bottom surface 48. The sloped gripping surface 57 may have a surface grip 46A (diagonal) or surface grip 46B (diamond knurl). These configurations are counter intuitive and thus non obvious to traditional prior art with essentially vertical notches to the horizon.

FIGS. 2 G through 2 I are similar sketches of the easy grip for bottles device 30,36 with components and features noted but portrayed as an Alternative 3. Portrayed in these views are: easy grip for bottle cap/closure device 36, a Special bottle cap opening/gripping device with step cut gripping rings 50 centered off set a distance OS from center aperture 45; a chamfer 41 on circumference; a predetermined, set thickness 41T of easy grip device 36 (example 0.75, 1.00, 1.25 inches etc.); a circumference 42; a circumference surface 42A; a diameter 43; a center aperture/through hole 45; a surface grip 46A on circumference surface 42A; a surface grip 46B on circumference surface 42A; a top surface 47 for logo, advertisement, etc.; a bottom surface 48 Lower surface starting from bottom surface and stepping to smaller ring upward; and a series of at least two step cut gripping rings 50. Remember the preferred embodiment 30 is centered on the device at the X-Y center point 32 and the through hole 45 at top surface 47. The step cut gripping rings 50 are also centered on point 32, 45. The FIGS. 2 G through 2 I is Alternative 3. Here the step cut gripping rings 50 are off set. In FIGS. 2 G through 2 I the rings 50 are centered on the center of the bottom step cut 49 at bottom surface 48. Thus, this creates an additional leverage arm OS between points 32 and 44 for the gripper 36 to hold the cap 65 as the device 30,36 is twisted. One skilled in the art of cutting rings appreciates this Alternative 3 could have the preferred squared steps 50 or rounded step cut gripping rings 50 and surface 46A (diagonal) or 46B (diamond knurl).

FIGS. 2 J through 2 L are similar sketches of the easy grip for bottles device 30,37 with components and features noted but portrayed as an Alternative 4. Portrayed in these views are: easy grip for bottle cap device 37, a Special bottle cap opening/gripping device with step cut gripping rings 50 centered off set angle OA (which is define as the acute angle to the perpendicular/essentially vertical line defined with Center point 32 and center of offset 49); a chamfer 41 on circumference; a predetermined, set thickness 41T of easy grip device 37 (example 0.75, 1.00, 1.25 inches etc.); a circumference 42; a circumference surface 42A; a diameter 43; a center aperture/through hole 45; a surface grip 46A (diagonal) on circumference surface 42A; a surface grip 46B (diamond/double knurl) on circumference surface 42A; a top surface 47 for logo, advertisement, etc.; a bottom surface 48; and a series of at least two step cut gripping rings 50. Remember the preferred embodiment 30 is centered on the device at the X-Y center point 32 and the through hole 45 at top surface 47. The step rings 50 are also centered on point 32, 45. The FIGS. 2 J through 2 L is Alternative 4. Here the step cutting rings 50 are off set on an angle OA. In FIGS. 2 J through 2 L the step cut gripping rings 50 are centered on the line defined from center point 32 extending to the center of the bottom step cut 49 at bottom surface 48. This line is defined as acute angle OA. Thus, this angled offset creates an additional leverage arm OS between points 32 and 44 for the gripper 37 to hold the cap/closure 65 as the device 30,37 is twisted. One skilled in the art of cutting rings appreciates this could have the preferred squared steps 50 or rounded step cut gripping rings 55 and configured surfaces diagonal 46A and diamond knurl 46B.

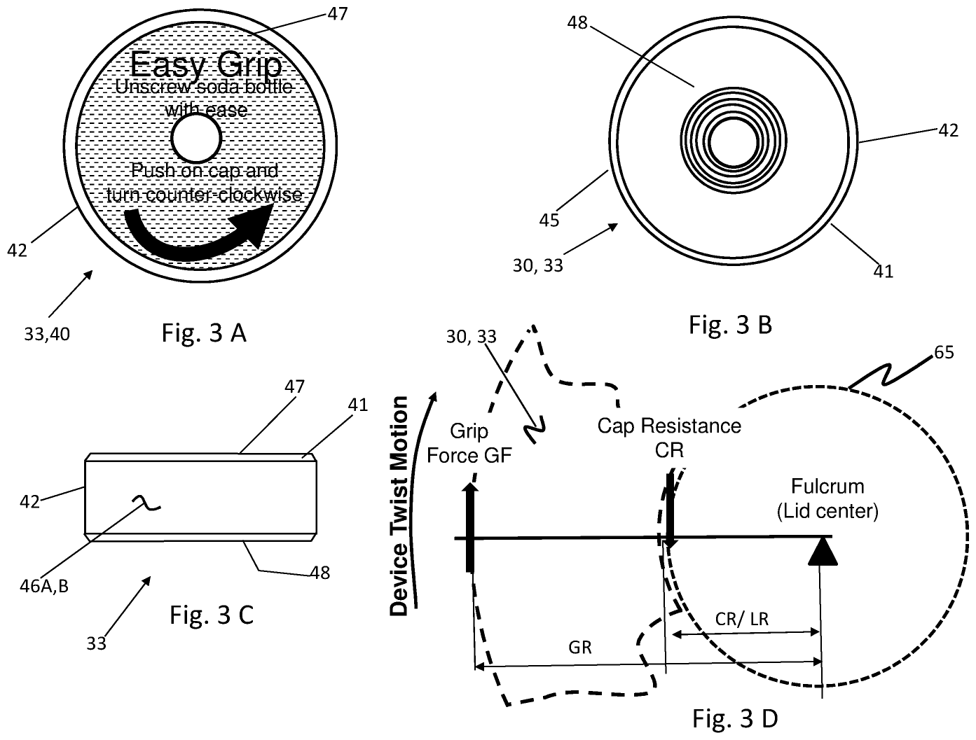

FIGS. 3 A through 3 D are additional sketches. FIGS. 3 A through 3 C show the prototype sample of the easy bottle cap grip device 30, 33 with the components and features shown from generally a top view. Here, the components and features demonstrated are: an easy grip for bottle cap/closure device 30 a Special bottle cap opening/gripping device; a prototype 33 of easy grip for bottle cap device; a Top view 40 of prototype 33 of easy grip 30; a chamfer 41 on circumference; a circumference 42; a circumference surface 42A; a diameter 43; a center aperture/through hole 45; a surface grip 46A on circumference surface 42A; a surface grip 46B on circumference surface 42A; a top surface 47 for logo, advertisement, etc.; a bottom surface 48; and a series of at least two step cut gripping rings 50. A common device could be, for example and not as a limitation, a three inch diameter, one inch thick and a step cut from a three-quarter inch hole to a one and a quarter inch hole. Also, shown in FIG. 3 D are the engineering concepts where the Cap Resistance force CR; Original Twist force TF; Gripper Twist Force GF; Lid radius LR; Gripper Radius GR; and Mechanical advantage or increase force MADV=GR/LR are demonstrated. This condition is known as a Class 2 fulcrum or lever. Here, the resistance (or load) in the middle (i.e. resistance force CR of the cap/closure): the effort is applied on one side of the resistance (at the lid or at the gripper device 30 circumference 42, 42A a d the fulcrum (gripper radius GR) is located on the other side. Examples of a Class 2 fulcrum are a wheelbarrow, a twist jar opener, a nutcracker, a bottle opener or the brake pedal of a car. Load/resistance arm (cap radius CR) is smaller (shorter) than the effort arm. (gripper radius GR). The mechanical advantage is always great r than one (1). This is often called a force multiplier lever. For example, a lid with a diameter of two (2) inches and a special bottler cap/closure opening/gripping device 30 with a diameter of four (4) inches. The radiuses are respectively one (1) for the lid radius LR and two (2) for the gripper radius GR. Therefore, with the gripper 30, there is a MADV-GR/LR=[2/1]=[2] or a mechanical advantage MADV of two (2). That means a twist force TF of say twenty-two (22) pounds on the cap/closure 65 by an operator 100 is mechanically advantaged by two to one [2:1]. Therefore, that same force of twenty-two (22) pounds onto the gripper GF doubles to become forty four (44) pounds on the cap/closure 65 using gripper device 30.

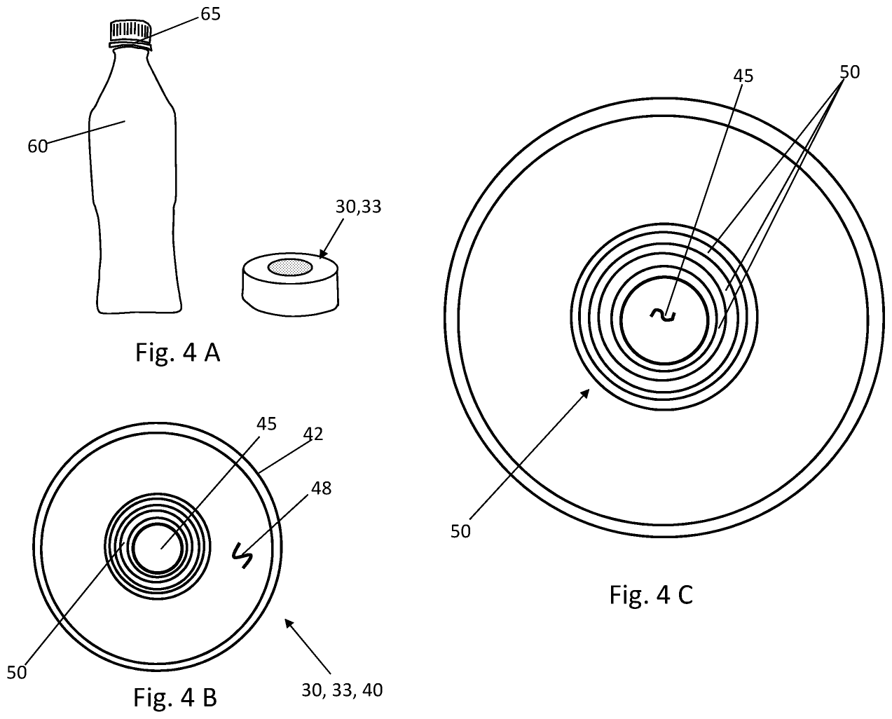

FIGS. 4 A through 4 C are additional sketches of the easy grip for bottle caps device 30. Once again components revealed are: an easy grip for bottle cap device 30 a Special bottle cap opening/gripping device; a prototype 33 of easy grip for bottle cap device; a Top view 40 of prototype 33 of easy grip 30; a circumference 42; a center aperture/through hole 45; a bottom surface 48; a series of at least two step cut gripping rings 50; a bottle 60; and a bottle cap/closure 65.

A Special bottle cap opening/gripping device 30 is made of a resilient and durable material. The material is made for easy manufacturing but with some resilience and flexibility to deflect and move somewhat in order to engage and grip the cap or object. This small give or bending allows the device 30 to adhere, attach or hold the object as the gripping and turning/twisting of the cap or object occurs. Materials anticipated, for example but not as a limitation to the device, include vulcanized rubber such as used with hockey pucks as in ice hockey. Vulcanization is a chemical process for converting natural rubber or related polymers into more durable materials by heating them with sulfur or other equivalent curatives or accelerators. These additives modify the polymer by forming cross-links (bridges) between individual polymer chains. Other materials may include a natural and synthetic rubber with a fairly high durometer or hardness rating [hardness of approximately 90 durometer (duro)]. Also, a urethane, nylon, reinforced nylon, polyvinyl chloride (PVC), silicone, Pebax® Elastomers—A family of lightweight polymers, or other composite materials with a similar durometer and good machinability (for the steps). Finally, in this modern times, and owing to their great flexibility and high thermal and media resistance, thermoplastic elastomers (TPE) now represent the near perfect alternative to vulcanized rubber. TPE can be melted, extruded injection-molded, pressure molded, thermos set or thermos plastic, and offer a range of technical processing advantages such as bio-compatibility, hygiene and sterilizability.

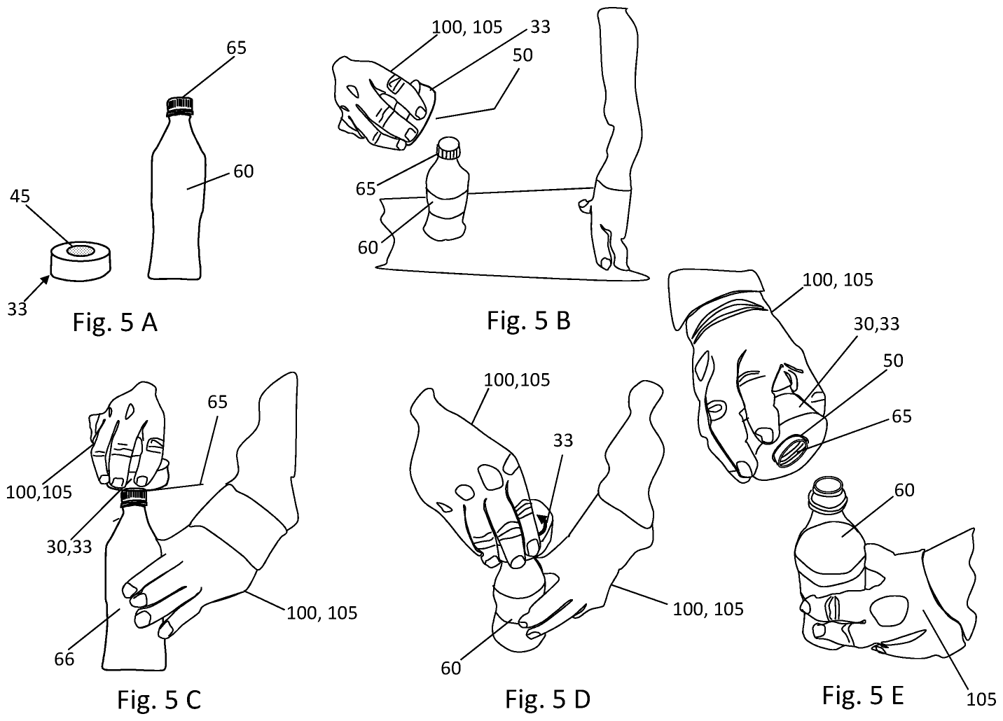

FIGS. 5 A through 5 E are sketches of operating and using 70 the easy grip for bottle cap device 30. This is described below in the operation section.

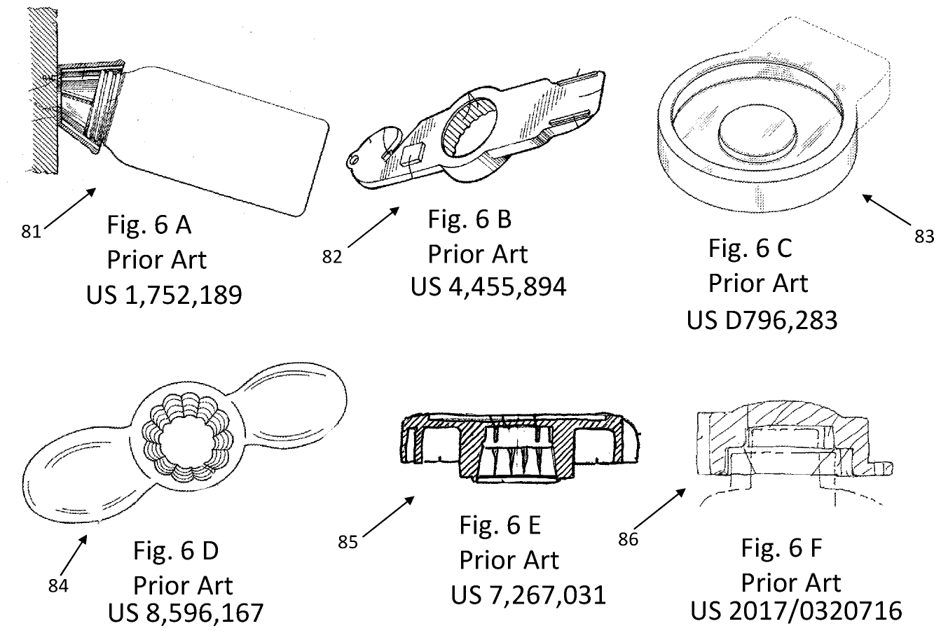

FIGS. 6 A through 6 F are sketches of prior art for bottle cap gripping devices. Here former patents and applications for various bottle cap gripping and opening devices are shown. These include: prior art device 81 is U.S. Pat. No. 1,752,189; prior art device 82 is U.S. Pat. No. 4,455,894; prior art device 83 is U.S. Pat. D 796,283; prior art device 84 is U.S. Pat. No. 8,596,167; prior art device 85 is U.S. Pat. No. 7,267,031; and prior art device 86 is Application 2017/0320716. As can be seen, the Special bottle cap opening/gripping device 30 called an Easy Grip is a unique combination and use as described herein.

The details mentioned here are exemplary and not limiting. Other specific components and manners specific to describing a Special bottle cap opening/gripping device 30 called an Easy Grip may be added as a person having ordinary skill in the field of the art of gripping and opening devices and the like well appreciates.

### Operation of the Preferred Embodiment

The Special bottle cap opening/gripping device 30 called an Easy Grip has been described in the above embodiment. The manner of how the device operates is described below. One notes well that the description above and the operation described here must be taken together to fully illustrate the concept of the bottle cap opening/gripping device 30. The preferred embodiment of the Special bottle cap opening/gripping device 30 called an Easy Grip is made of a resilient and durable material and is comprised of features: (a) a circumference 42 for a given diameter 43, the circumference having a circumference surface 42A, a surface grip 46A, 46B and a chamfer 41 on circumference edges; (b) a set thickness 41T; (c) a top surface 47 for logo, advertisement, etc.; (d) a bottom 48 having a series of step cut gripping rings 50; and (e) a center aperture/through hole 45 from the top surface 47 through to the bottom 48 wherein an operator 100 uses the device 30 and engages the top of a bottle cap/closure 65 with the series of step cut gripping rings 50 and thereby holding the cap/closure 65 while the operator 100 then can twist the diameter 43 of the device 30 by holding a circumference surface 42A which permits the device to grip the bottle cap at gripping rings 50 and to multiply the twist force with the radius of the device and thereby turn the cap/closure 65 more easily than by just the hand 105 of the operator 100 gripping the cap 65/closure alone.

FIGS. 5 A through 5 E are sketches of the operation or using 70 of the easy grip for bottle cap device 30. Components and features provided include: a Special bottle cap opening/gripping device 30; a prototype 33 of easy grip for bottle cap device; a center aperture/through hole 45; a surface grip 46A on circumference surface 42A; a surface grip 46B on circumference surface 42A; a series of at least two step cut gripping rings 50; a bottle 60; bottle cap/closure 65; an operation of un-screwing 70 bottle cap/closure 65 by operator 100; an operator 100; and a hand(s) 105 of operator 100. The Steps are:
A. Obtain the closed bottle 60 or object and the gripping device 30.
B. Place the aperture 43 with the bottom side 48 and series of step grips 50 over the cap/closure 65 of the bottle 60.
C. Begin the turn/twist (normally counterclockwise) the device 30 by gripping the circumference 42 and surface 42A with the operator's hand(s) 105.
D. As the steps 50 grip the cap/closure 65, exert more force onto the device 30 by the hand(s) 105.
E. As the cap/closure 65 breaks free, reduce the grip force and then complete removing the cap/closure 65 by unscrewing the cap/closure 65 until it is free from the top of the bottle 60.
F. Remove the cap/closure 65 from the interior steps 50 of the device 30.
G. If desired to replace the cap/closure 65 onto the bottle 60, reverse the process by placing the cap/closure 65 onto the top of the bottle 60.
H. Turn (normally clockwise to tighten) the cap/closure 65 until the cap/closure 65 is tight on the bottle 60. At the end of twisting the device 30, exert one last, more forceful turn of the device 30 thereby firmly tightening or locking the top 65 onto the bottle 60.

Many uses are anticipated for the special bottle cap opening/gripping device 30 called an Easy Grip. Some examples, and not limitations, are shown in the following Table.

TABLE C
Uses.

| ITEM | DESCRIPTION |
|---|---|
| 1 | Beverage bottles - soda pop, thirst quenchers, fruit drinks, dairy |
| | products and the like |
| 2 | Food bottles such as salad dressings, hot sauces, soy sauce and |
| | condiments |
| 3 | Twist handles needing extra grip such as garden hose spigots, |
| | round sink handles, and other household plumbing fixtures |
| 4 | Pill bottles and various medicine and health aid containers |
| 5 | Wine bottles and boxes |
| 6 | Gallons/quarts of water and milk, etc. |
| 7 | Power drinks |

With this description it is to be understood that the special bottle cap opening/gripping device 30 called an Easy Grip is not to be limited to only the disclosed embodiment of product. The features of the gripping and turning device 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it being understood that only selected embodiments have been shown and described and that all changes, modifications and equivalents that come within the spirit of the disclosures described heretofore and or/defined by the following claims are desired to be protected.

1. A bottle cap opening/gripping device (30) made of a resilient and durable material and is comprised of a group of features:
(a) a circumference (42) for a given diameter (43), the circumference having a circumference surface (42A), a surface grip and a chamfer (41) on circumference edges;
(b) a predetermined, set thickness (41T);
(c) a top surface (47) for logo, advertisement;
(d) a bottom (48) having a series of step cut gripping rings (50); and
(e) a center aperture/through hole (45 from the top surface (47) through to the bottom (48);
wherein an operator (100) uses the device (30) and engages the top of a bottle cap (65) with the series of step cut gripping rings (50) and thereby holding the cap (65) while the operator (100) then can twist the diameter (43) of the device (30) by holding a circumference surface (42A) which permits the device to grip the bottle cap at gripping rings and to multiply the twist force with the radius of the device and thereby turn the cap (65) more easily than by just the hand (105) of the operator (100) gripping the cap (65) alone.

2. The bottle cap opening/gripping device (30) in claim 1 wherein the step cut gripping rings (50) are further comprised with step cut gripping rings (50) centered on the device (32) center point (32).

3. The bottle cap opening/gripping device (30) in claim 2 wherein the step cut gripping rings (50) is a group consisting of square stepped rings (50).

4. The bottle cap opening/gripping device (30) in claim 2 wherein the surface grip is selected from a group consisting of diagonal surface grip (46A) and diamond/double knurl surface grip (46B).

5. The bottle cap opening/gripping device (30) in claim 2 wherein the resilient and durable material is selected from a group consisting of vulcanized rubber, natural rubber with a fairly high durometer, synthetic rubber with a fairly high durometer, urethane, nylon, reinforced nylon, polyvinyl chloride (PVC), silicone, Pebax Elastomers®, thermoplastic elastomers (TPE), and composite materials.

6. The bottle cap opening/gripping device in claim 1 wherein the step cut gripping rings (50) are further comprised with step cut gripping rings (50) centered off set from center aperture (45) an off set distance (OS).

7. The bottle cap opening/gripping device in claim 6 wherein the step cut gripping rings (50) is selected from a group consisting of square stepped rings (50) and rounded stepped rings (55).

8. The bottle cap opening/gripping device in claim 6 wherein the surface grip is selected from a group consisting of diagonal surface grip (46A) and diamond/double knurl surface grip (46B).

9. The bottle cap opening/gripping device in claim 6 wherein the resilient and durable material is selected from a group consisting of vulcanized rubber, natural rubber with a fairly high durometer, synthetic rubber with a fairly high durometer, urethane, nylon, reinforced nylon, polyvinyl chloride (PVC), silicone, Pebax Elastomers®, thermoplastic elastomers (TPE), and composite materials.

10. The bottle cap opening/gripping device (30) in claim 1 wherein the step cut gripping rings (50) are further comprised with step cut gripping rings (50) centered off set on an offset angle (OA) from center aperture (45).

11. The bottle cap opening/gripping device in claim 10 wherein the step cut gripping rings (50) is selected from a group consisting of square stepped rings (50) and rounded stepped rings (55).

12. The bottle cap opening/gripping device in claim 10 wherein the surface grip is selected from a group consisting of diagonal surface grip (46A) and diamond/double knurl surface grip (46B).

13. The bottle cap opening/gripping device in claim 10 wherein the resilient and durable material is selected from a group consisting of vulcanized rubber, natural rubber with a fairly high durometer, synthetic rubber with a fairly high durometer, urethane, nylon, reinforced nylon, polyvinyl chloride (PVC), silicone, Pebax Elastomers®, thermoplastic elastomers (TPE), and composite materials.

14. A bottle cap opening/gripping device (30) made of a resilient and durable material and is comprised of a group of features:
(a) a circumference (42) for a given diameter (43), the circumference having a circumference surface (42A), a surface grip and a chamfer (41) on circumference edges;
(b) a predetermined, set thickness (41T);
(c) a top surface (47) for logo, advertisement;
(d) a sloped cut gripping ring (57), essentially a sloped grip area starting from the top surface (47) at the aperture (45) and widening/increasing in diameter to the bottom surface (48); and
(e) a center aperture/through hole (45) from the top surface (47) through to the bottom (48);
wherein an operator (100) uses the device (30) and engages the top of a bottle cap (65) with the sloped cut gripping ring (57) and thereby holding the cap (65) while the operator (100) then can twist the diameter (43) of the device (30) by holding a circumference surface (42A) which permits the device to grip the bottle cap at sloped cut gripping ring (57) ring and to multiply the twist force with the radius of the device and thereby turn the cap (65) more easily than by just the hand (105) of the operator (100) gripping the cap (65) alone.

15. The bottle cap opening/gripping device in claim 14 wherein the surface grip is selected from a group consisting of diagonal surface grip (46A) and diamond/double knurl surface grip (46B).

16. The bottle cap opening/gripping device in claim 14 wherein the resilient and durable material is selected from a group consisting of vulcanized rubber, natural rubber with a fairly high durometer, synthetic rubber with a fairly high durometer, urethane, nylon, reinforced nylon, polyvinyl chloride (PVC), silicone, Pebax Elastomers®, thermoplastic elastomers (TPE), and composite materials.
